(19) United States
(12) Patent Application Publication
(10) Pub. No.: US 2019/0095941 A1
(43) Pub. Date: Mar. 28, 2019

(54) METHOD, SYSTEM AND DEVICE FOR HANDLING CASHLESS PAYMENTS WITH A PAYMENT INSTRUMENT

(71) Applicant: ZENCARD SP. Z O.O., Warsaw (PL)

(72) Inventor: Krzysztof KLIMCZAK, Warsaw (PL)

(21) Appl. No.: 16/090,754

(22) PCT Filed: Apr. 3, 2017
(86) PCT No.: PCT/PL2017/000035

§ 371 Date: Oct. 2, 2018

(30) Foreign Application Priority Data
Apr. 4, 2016 (PL) P.416750

(51) Int. Cl. G06Q 30/02; G06Q 20/40

(52) U.S. Cl. CPC G06Q 30/0229; G06Q 20/40

(57) ABSTRACT

A method for handling cashless payments with a payment instrument, which includes receiving an order to carry out a cashless payment with a payment instrument, reading out the identifier of this payment instrument, generating a secondary identifier by modifying the identifier of the payment instrument using a hash function, establishing communication with a receiver of a central trade transactions carrying out system, transmitting the generated secondary identifier to the receiver of the central trade transactions carrying out system in order to check whether any material benefit appertains to the customer, receiving information from the central trade transactions carrying out system about the material benefit granted to the customer, authorizing the transaction, and charging the customer's account including the material benefit granted in the previous step. Also provided is a system for handling cashless payments with a payment instrument, and a device for handling cashless payments.

### TECHNICAL FIELD

This invention relates to a method and a device for handling cashless payments with the use of a payment instrument, particularly with rewarding for trade transactions in form of rebate actions, the payments being done by means of a payment card or a mobile device, particularly in trade facilities that offer, to their customers, tangible rewards or rebates, e.g., according to loyalty programs. Also, the subject matter of the invention is a system for handling cashless payments, particularly with rewarding for trade transactions in a form of loyalty programs coming from at least one trade party, in which a customer is rewarded in various ways when doing a payment. The invention also relates to a device for performing this method.

### STATE OF THE ART

Methods for carrying out payments are known commonly, including offering rebates or price reductions for bought goods. For example, shop receipts have indications of goods with prices for individual items, unit prices, amounts of articles, tax rates for given products and other important data, in particular discount rates granted for given products within price reduction actions or because of the amount of bought products, as well as because of special points gained within loyalty programs. Moreover, situations take place frequently, in which a buyer, when making the payment, enjoys a previously granted allowance, for example from previous purchases, and exercises his/her rebate granted thereby. So, in known methods, performing a payment includes, first, a step of accounting rebates granted previously due to various loyalty/savings programs functioning in individual shops, and then, a step of doing the payment for the purchased goods. Such payment methods are practiced in big-box stores as well as in petrol stations, in pharmacies, restaurants, air lines, travel agencies, hotels or other shopping or service point-of-sale, and include various loyalty programs intended to prompt customers to purchasing goods or services in particular trade facilities, where the customers, in return, are rewarded in a particular way. The rewards may have forms of points, vouchers and discount coupons, or other particular things.

Systems exist in the market that handle the rewarding for trade transactions in which a customer receives tangible awards or an allowance for future purchases by offering a loyalty card in which, for example, points are collected. In these systems cards are available such as paper forms, plastic cards, smart cards or virtual cards associated with an Internet application. The loyalty card, after connecting, via an access network, to an authentication/authorization system, allows for identifying a customer and registering, in his/her account, the transaction amount, granted points, or ordering a coupon with a reward. Known systems require, however, a customer to possess many cards that identify him/her, usually a separate card for every seller. Moreover, the existing systems are quite troublesome since they perform an additional process in parallel to the process of payment for purchased services or goods. It should be noticed that loyalty programs presently functioning in the market are not able to change the transaction amount that is being performed. They only are able to inform the customer, for example by means of a print from a terminal or sending an SMS message, or a notification by means of the electronic mail, about adding relevant points and issuing a discount coupon for future purchases. So, the transaction performed within existing loyalty programs, that is to be covered by the rebate, needs additional actions on the side of the customer. Firstly, the customer must have the coupon or loyalty card with him/her at the moment of doing the transaction, and must show this coupon or the card to the seller before starting the payment procedure. Cards issued in the so called multipartner system function in a similar way, the cards making it possible to use a given card and collect points in return for purchasing goods or services in various points of sale, i.e., not being tied to a specific seller. Usually, a single party is responsible for controlling such a system. An example of this may be the Sodexo group offering, among others, such services.

Also, devices are known for realizing cashless payments, including giving price rebates or discounts for purchased goods. Such a device in the form of a terminal is equipped with communications means that communicate with a superior system of the clearing system, and also has a display, a magnetic stripe reader, a proximity card reader, a smart card reader, a payment handling module, a keyboard, and a module for cooperation with a printer. Such terminals posses programmable circuits, that facilitate identification of products by identification means such as barcodes, RFID labels and other known elements devoted for unequivocal identification of products. Moreover, the software of such a device makes it possible to easily integrate such terminals with the whole clearing system of the store.

From WO2015009581A1 various systems and methods are known for delivering and operating rewards and allowances at automatic payments, independently on the clearing agent, and outside of the terminal, particularly with the use of a tablet or a smartphone, using an SMS message, electronic mail, push operation, or a website. The disclosed process of earning rewards and discounts is based on registering this action in an account associated with a payment card. However, an inconvenience of those methods for earning rewards and discounts is that they are realized along with the transaction authorization, when one needs data of the payment card or another payment instrument, the data being stored for this purpose. Therefore, the earned rewards and discounts are consumed only at a future transaction. Besides, it is impossible to display this information on the terminal or to print it with a printer, the only information shown to a customer being the information about the transaction itself.

Moreover, from WO2014084758A2, it is known a method and a system for making payments using loyalty programs and with rewarding customers within a single authorization/clearing center. So, a significant limitation of that solution is the possibility of cooperation with a single clearing agent only.

WO2013022376A1 discloses a method for clearing a transaction, but it does not realizes any discounts or grants rewards before the payment, and, moreover, it needs both the seller and the buyer to communicate with a clearing server. Furthermore, it is not known if specially issued cards are used therewith or any payments cards may be used.

Additionally from US2015161642A1 a method is known for verifying if a customer belongs to a loyalty program of a given merchant. However that method is based on sending authorization messages during the payment process. So, in fact, it is performing two payment transactions: a pre-authorization that verifies the financial means and returns the mapping of the user to the program, and the actual charging that may be done for an adjusted transaction amount. It is clearly said that a payment card account number (PAN) is used and it is verified whether it is associated with a loyalty program, and then the customer identifier ID is used. The inconvenience here is the necessity of sending several authorization requests, sending sensitive data, for example the PAN number, or the necessity of having and presenting a unique ID.

Therefore, a demand exists for a method for making payments accounting rebates, discounts, or granted rewards, including also the current payment, covering many points of sale and independently on an authorization center.

Also, a system would be needed for clearing payments, integrating many loyalty programs and including various allowances and discounts offered by different sellers, the system operating on the basis of a single payment card, without activating special coupons nor storing sensitive data present on the payment card, the system making it possible to benefit from these discounts during a currently performed transaction.

So, the main inconvenience of such systems existing so far in the market is that they are not able to adjust the payment amount for the carried out transaction. Including discounts granted during the current payment.

Therefore, the main objective of the present invention is to provide a method for handling cashless payments, wherein discounts appertaining to the customer are identified and automatically calculated before carrying out the payment transaction using any particular payment instrument.

Moreover, a further objective of the present invention is to make it possible to verify if a customer takes part in any particular promotion action or loyalty program at a given seller, and, if he/she does not, to make it possible to him/her to register and join such actions and programs.

Moreover, a further objective of the present invention is to increase the safety of cashless transactions by designing and using a unique and repeatable encoded string of characters identifying unequivocally the payment card number, out of the personal data or other sensitive data identifying the cardholder, in order to avoid the need of processing, registering and storing the personal data.

Another objective of the invention is to provide a system for carrying out cashless payments, that facilitates collecting, by a customer, allowances, discounts or points within loyalty programs from many sellers in the market, and guarantees the realization of the allowances, discounts or points including all purchases made so far.

Also, the aim of the invention is to provide a payment device that, being a part of a system for handling cashless payments, makes it possible to realize the method according to the invention.

A method for handling cashless payments with a payment instrument, according to the invention, comprises:
receiving an order to carry out a cashless payment with a payment instrument, reading out the identifier of this payment instrument,
generating a secondary identifier by modifying the identifier of the payment instrument using a hash function,
establishing communication with a receiver of a central trade transactions carrying out system,
transmitting the generated secondary identifier to the receiver of the central trade transactions carrying out system in order to check whether any material benefit appertains to the customer,
receiving information from the central trade transactions carrying out system about the material benefit granted to the customer,
authorizing the transaction, and
charging the customer's account including the material benefit granted in the previous step.

In the method according to the invention, the granted material benefit may have a value of zero.

In the method according to the invention, the step of transmitting the generated secondary identifier to the receiver of the central trade transactions carrying out system is also performed in order to verify if the customer is registered in said central transaction system. If the result of this verification is negative, the method comprises a step of receiving, from the central trade transactions carrying out system, information about a possibility of registering the customer in said central transaction system, the registration being carried out after confirming the payment transaction.

In the method according to the invention, the step of reading out the identifier of the payment instrument is performed by reading out the PAN number of the payment card or a phone number, or any customer's password or the identifier of any payment instrument used by the customer for making payments.

In the method according to the invention, a hash function is used for generating the secondary identifier.

The information about the granted material benefit may be displayed on the payment terminal screen or the payment instrument screen. Alternatively, this information may be printed on a printer or generated as a sound signal. Alternatively, the information about the granted material benefit may be sent to the customer as a text message and/or via email.

Another aspect of the invention is a device for handling cashless payments with a payment instrument, comprising:
means for receiving an order to carry out a cashless payment with a payment instrument,
means for reading out the identifier of this payment instrument,
means for generating a secondary identifier by modifying the identifier of the payment instrument using a hash function,
means for establishing communication with a receiver of a central trade transactions carrying out system,
means for transmitting the generated secondary identifier to the receiver of the central trade transactions carrying out system in order to check whether any material benefit appertains to the customer,
means for receiving information from the central trade transactions carrying out system about material benefits granted to the customer,
means for authorizing the transaction.

According to the invention, the granted material benefit may have a value of zero.

The device comprises means for sending, to the customer, information about the material benefit. If the verification is negative, the device has means for receiving information about the possibility of registering the customer in said central transaction system, the registration being carried out after confirming the payment transaction.

Moreover, the device has means for reading out the identifier of the payment instrument by reading out the PAN number of the payment card, alternatively a phone number, or any customer's password or the identifier of any payment instrument.

Also, the device according to the invention has means for using a hash function for generating the secondary identifier.

A system for handling cashless payments, according to the invention, with a payment instrument, comprises a device for handling cashless payments and a central trade transactions carrying out system, the device comprising:
means for receiving an order to carry out a cashless payment with a payment instrument,
means for reading out the identifier of this payment instrument,
means for generating a secondary identifier by modifying the identifier of the payment instrument using a hash function,
means for establishing communication with a receiver of the central trade transactions carrying out system,
means for transmitting the generated secondary identifier to the receiver of the central trade transactions carrying out system in order to check whether any material benefit appertains to the customer,
means for receiving information from the central trade transactions carrying out system about material benefits granted to the customer,
means for authorizing the transaction.

In the system according to the invention, the amount of the granted material benefit does not depend on the type of the payment instrument with which the payment is done.

Thanks to the system according to the invention the effectiveness of special promotion actions increases significantly, being even up to ten times higher than in traditional promotion programs. Moreover, it is possible to realize cross-promotions with complementary products, this decreasing costs of acquiring new customers. Simulation research, related to a reference customer, gave a transaction median higher by about 20% when using the proposed system.

Also, the system according to the invention significantly reduces the costs of own loyalty programs that are offered by single sellers, because such a system facilitates cross-promotions along with other parties in the market, so data related to multiple loyalty programs are not isolated. Moreover, in contrast to other systems basing on payment cards, this system makes it possible to reward customers for their loyalty in a non-money manner, i.e., with rewards for the volume or frequency of purchases.

Finally, this system makes it possible to define a loyalty card with many status levels (for example silver, gold, platinum etc.), that creates an emotional bond of the customer to the given brand, and also this system makes it easier to monitor the results of advertising campaigns or promotions in real time.

### BRIEF DESCRIPTION OF THE DRAWINGS

The present invention will be apparent and better appreciated from the following detailed description in conjunction with the accompanying figures in which:

FIG. 1 shows a method for handling cashless payments with a payment instrument in a first embodiment of the present invention;

FIG. 2 shows a method for handling cashless payments with a payment instrument in a second embodiment of the present invention,

FIG. 3 shows a method for handling cashless payments with a payment instrument in a third embodiment of the present invention,

FIG. 4 shows system for handling cashless payments with a payment instrument in an embodiment of the present invention,

FIG. 5 shows a device for handling cashless payments with a payment instrument in an embodiment of the present invention.

### DETAILED DESCRIPTION OF THE INVENTION

The drawing show a system 300 for handling cashless payments with a payment instrument. The system allows for very elastic management of granting material benefits, a material benefit, as used herein, being understood as, for example, a discount granted to a customer when buying a good or a service, a reward for reaching a particular volume or frequency of purchases, points within a loyalty program, gifts for customers, lotteries for customers using this solution or others. Moreover, stores, both stationary as well as virtual, may grant material benefits. According to the invention, all of this is possible within a single system for handling cashless payments with a payment instrument.

In an embodiment, the customer's payment instrument has a form and a format of a card, such as known payment cards. A magnetic stripe or, preferably, an electronic chip may serve as a data carrier. Also, in alternative embodiments, the function of the payment instrument may be performed by another data carrier, for example a pen-drive type flash memory, a mobile phone, or another device guaranteeing safe data write/read operations.

The system 300 comprises a central transaction system 250 for carrying out trade transactions, and a payment terminal 200, for example a device for handling cashless payments according to the invention. The payment terminal 200 for handling cashless payments is identified basing on a unique identifier, for example an address of a type of Media Access Control (MAC), and is connected to the central transaction system 250, a network for transmitting data and/or voice (for example Internet, X.25 or another network). Generally, the term “network” is understood in the following description as a web of connections making it possible to send data or data/voice independently on the applied technology.

The term “hash function” denotes a function that assigns, to any arbitrary input data, for example to a string of alphanumeric characters of any length, a constant length, non-specific quasi-random value, so called a non-reversible hash value. According to the invention, any safe hash function is used that causes the anonymization of the payment instrument data. For example, it is a cryptographic hash function, such as the hash function SHA-2, for example SHA-256 or SHA-512. Generating the secondary identifier by means of cryptographic hashes may comprise, additionally, adding a string of alphanumeric characters to selected digits of a read out payment instrument identifier. For example the payment card PAN number is blanked out, and a cryptographic hash function SHA-2 is created, for example SHA-256 or SHA-512. Also, the generating the secondary identifier may use any one-way algorithm that guarantees the impossibility of determining the initial key basing on a derivative key. Any other method of encoding may be used that is suitable to be used with the method according to the invention. Since such solutions are known, they will not be described in more detail in this document.

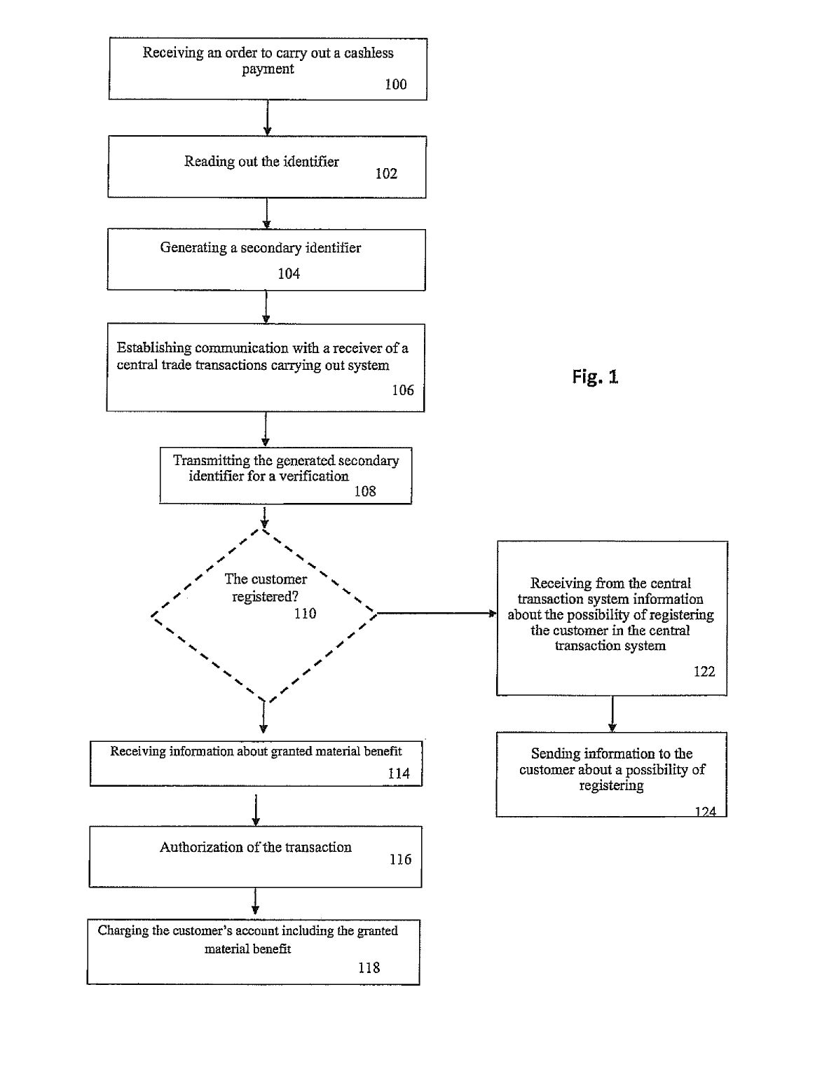

A method for handling cashless payments in one embodiment shown in FIG. 1 comprises the following steps. Receiving, 100, an order to carry out a cashless payment with a payment instrument. This step is realized when carrying out a transaction, at the moment of computing the amount to be paid by the customer. Next, the payment instrument identifier is read out, 102, by the payment terminal, 200, and a secondary identifier is generated, 104, for the payment instrument, by modifying the payment instrument identifier using a hash function. As a result, one obtains a resulting string of characters that constitutes a unique and repeatable secondary identifier. After establishing the communication, 106, with a receiver of a central trade transaction system 250 (here called also a central transaction system), the generated secondary identifier is transmitted, 108, to the receiver of the central transaction system 250 in order to check if any material benefit appertains to the customer. The central transaction system 250 sends, 114, information about material benefits granted to the customer. After receiving this information, the authorization of the transaction is performed, 116, and the customer account is charged, 118, including any previously granted material benefit.

In an alternative embodiment of the method according to the invention, the generated secondary identifier is transmitted to the receiver of the central transaction system 250, also for verifying, 110, whether the customer is registered in the central transaction system 250. In the case of negative verification, 110, according to the present embodiment, the method comprises a step of receiving, 122, from the central transaction system 250, information about the possibility of registering the customer in the central transaction system 250. Next, it sends, 124, information to the customer about a possibility of registering the customer according to the invention. Then, however, the granted material benefit has a value of zero. “Zero value material benefit” arises in a situation if no discounts appertain to the customer—“You are granted a discount of zero.”

In the method according to the invention, the step of reading out, 102, the payment instrument identifier is performed by reading out the payment card PAN number. Every payment card has its own, individually assigned number, basing on which the card issuer may be identified. The card issuer identifier is constituted by the first 6 digits embossed or printed on the card. The next term within the card number is the PAN number, i.e., the Primary Account Number, that not necessarily has to be the customer account number, and may be given by the card issuer as a secondary account number. Finally, the last term of the card number is a check digit.

Alternatively, the step of reading out, 102, is performed by entering a phone number or any other password assigned to the customer. The secondary identifier is generated, 104, using a secure hash function.

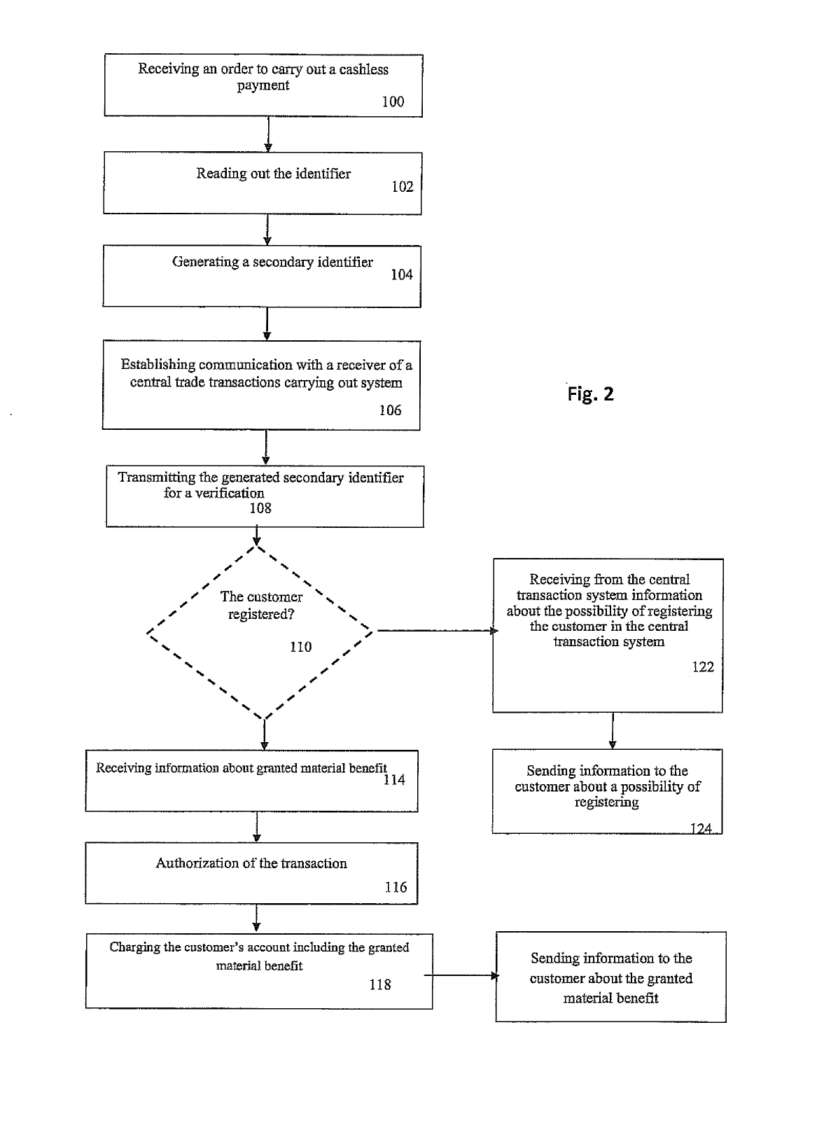

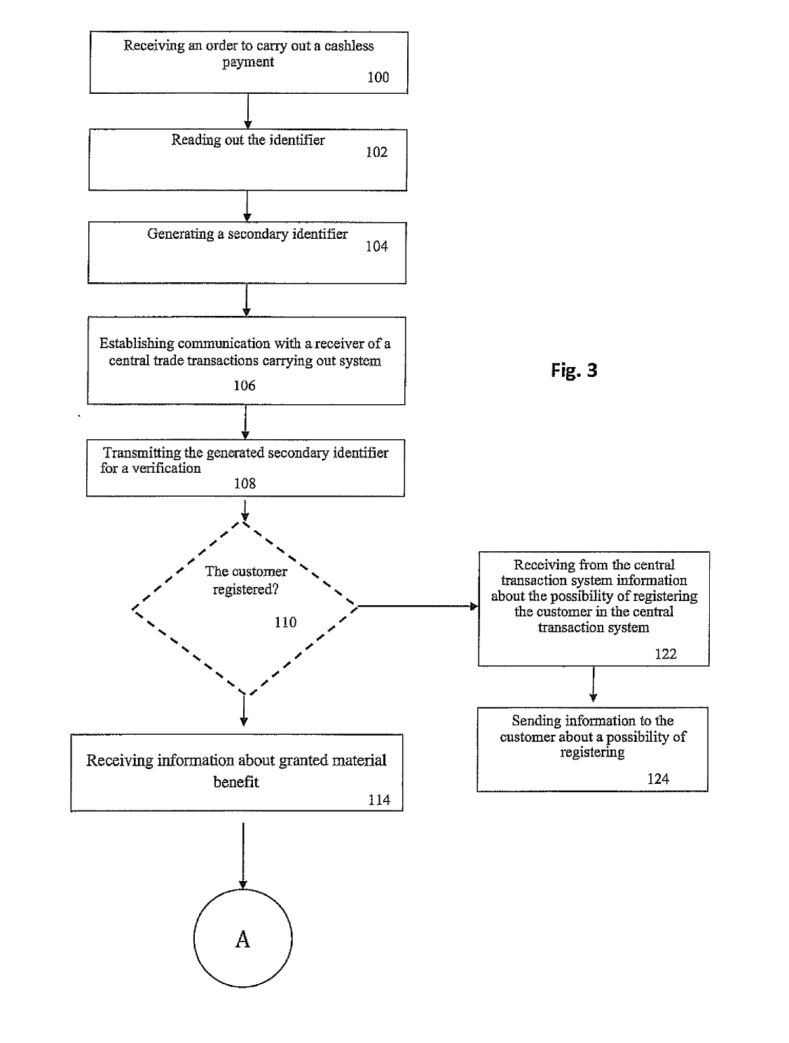

In an alternative method according to the invention shown in FIG. 2, an order to carry out a cashless payment with a payment instrument is received, 100, by starting the payment operation. Here, first of all, the amount to be paid by the customer is calculated. The payment instrument may be for example a payment card, mobile phone, any customer's password as well as any other suitable payment instrument. The amount to be paid for the purchase is entered, without notifying by the seller about granted discounts or rebates. At this moment, there is no need to document any participation in any loyalty/discounts programs. The customer uses his/her payment instrument to carry out the payment by means of a payment terminal 200. The payment terminal may be formed by a device 400 according to the invention, a POS (point-of-sale) terminal, a computer POS terminal, as well as an Internet or mobile application. After inserting said customer's payment instrument into said payment terminal 200, the payment instrument identifier is read out, 102, automatically. Then, a secondary identifier of the payment instrument is generated, 104, wherein the assigning the secondary identifier is performed by reading out the payment instrument identifier, for example the payment card PAN number, a mobile phone number, or a web site registration code. The payment card PAN number or the mobile phone number is modified by means, for example, of safe hash functions or using any other encoding method. As a result, a resulting string of characters is obtained, that forms a unique and repeatable secondary identifier.

Then, communication is established, 106, with a receiver of a central trade transaction system 250 in order to check whether the customer is already registered within the system of granting discounts or points within any loyalty program. After establishing the communication successfully, 106, the generated secondary identifier is transmitted, 108, for its verification. If the customer is already registered in the central transaction system 250, information is received, 114, about granted material benefit. Such a benefit may be a discount, a tangible reward, points to be collected. This verification is performed by connecting the payment terminal 200 with the central transaction system 250, where said data are collected about linkages between the identifiers and the customer, as well as granted rewards and discounts.

The reception, 114, of the information consists in displaying this information on the screen of the payment terminal 200. Alternatively, this information may be printed on a printer connected to the payment terminal 200. In yet another embodiment, this information may be sent as an SMS message or as a sound signal. In yet another embodiment, this information may be transmitted to the payment terminal or a mobile device, the customer's computer, or to any device that makes it possible to receive the information about granted material benefits.

After receiving this information, 1.14, the granted material benefit is counted automatically and the amount to be paid is reduced. The customer accepts or rejects the granted material benefit. Then, the transaction is authorized, 116, and the customer's account is charged, 118, including the granted material benefit. The customer receives information, 120, about the granted material benefit. This information maybe displayed, 120, for example on the screen of payment terminal 200. Also, in an alternative embodiment, it may be printed, 120, on a printer, or generated, 120, as a sound signal.

An alternative embodiment of the method according to the invention relates to a situation when a customer is not registered in the central transaction system 250. The customer, when buying goods, gives it to a seller 100, to pay therefor. As in the above embodiment, first the amount to be paid is calculated. The customer inserts his/her payment instrument to a payment terminal that reads out, 102, the payment instrument identifier automatically. Then, it generates, 104, a secondary identifier of the payment instrument according to the invention and establishes, 106, a communication session with a receiver of the central transaction system 250 to check whether the customer is already registered in the central transaction system 250. After the communication is established, 106, successfully, it transmits, 18, the generated secondary identifier to the central transaction system 250. If it turns out, by verifying, 110, the secondary identifier, that the customer is not yet registered in the central transaction system, then the payment terminal 200 receives, from the central transaction system 250, a message that there is a possibility to register the customer in the central transaction system 250. This information is sent, 124, to the customer. The customer may register in ten central transaction system 250 after completing the payment transaction.

According to the invention, after registering a customer in the central transaction system 250, the central transaction system 250 identifies the customer automatically at every subsequent verification basing on his/her payment card PAN number, mobile phone number, or a password identifying the customer. Moreover, a customer may possess many payment cards, passwords and mobile phone, each of them having a unique number. An identifier is assigned to every number. So, independently on which payment card or mobile phone number is used for making a payment by the customer, the same material benefit is granted to him/her.

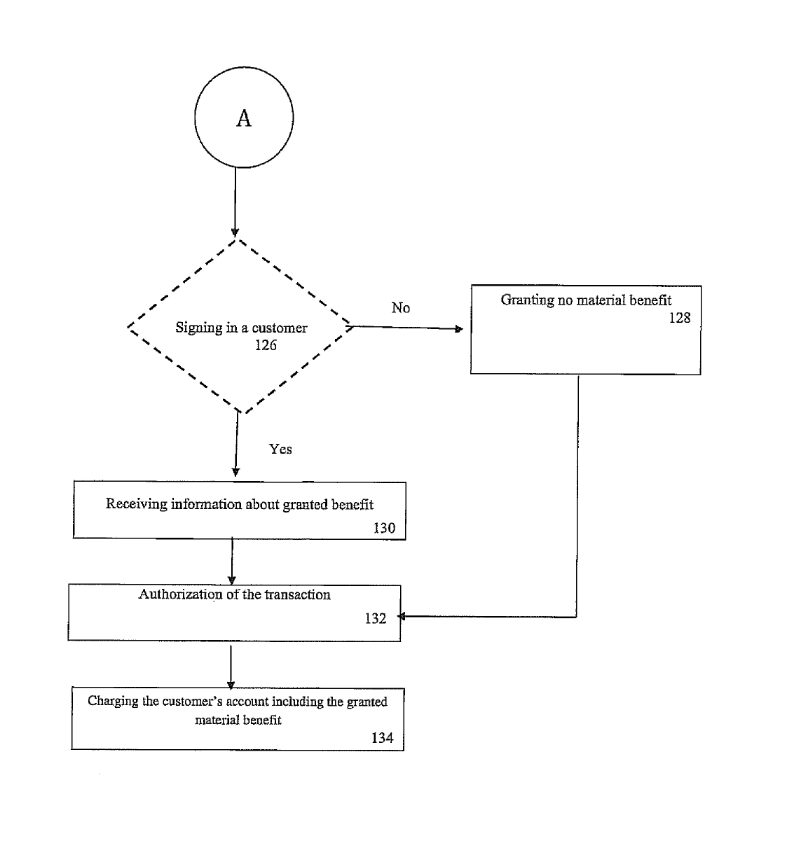

According to an alternative embodiment shown in FIG. 3, after the step of verifying, 110, and in order to exercise the granted material benefit, a customer is asked to log in, 126, to the central transaction system 250 to confirm his/her identity. When the customer signs in by entering an individual code, the code being, for example, a telephone number, password, or any string of alphanumeric characters assigned to the customer, a material benefit is granted to him/her. After accepting the benefit, the customer is asked for authorization, 132, of the transaction, and his/her account is charged, 134, for an amount including the granted material benefit. If, on the contrary, the customer wishes not to log in or has forgotten the individual code, no material benefit is granted, and he/she is asked to authorize, 132, the transaction without granting any material benefit. The granted material benefit has a value of zero.

The central transaction system 250 does not require to enter personal data. To identify a customer it is sufficient to enter merely the payment instrument identifier.

According to the invention, a system 300 for handling cashless payments with a payment instrument comprises a central transaction system 250 for carrying out trade transactions, and a device 200 for handling cashless payments. The device 200 comprises a processor 202 and a memory module 204 that stores instructions executed by the processor 202. Moreover, the device 200 comprises an interface 206 allowing for communication with a communication network and other devices via this communication network.

The system 300 comprises a central transaction system 250 that stores secondary identifiers assigned to a customer's payment card or to a customer, along with material benefits granted thereto, and has a device 200 comprising a memory module 204 with a data structure that stores secondary identifiers generated by a processor 202 and assigned to the customer's payment instrument, the device 200 having means 405 for receiving an order for handling a cashless payment with a payment instrument, means 402, 403, 404, 405 for reading out the payment instrument identifier, means 409 for generating the secondary identifier by modifying the payment instrument identifier using a hash function, means 407 for establishing communication with a receiver of the central transaction system, means 409 for transmitting the generated secondary identifier to the receiver of the central transaction system in order to verify whether any material benefit appertains to the customer, means 401, 408 for receiving information from the central transaction system about material benefits granted to the customer, means 406 for authorizing the transaction.

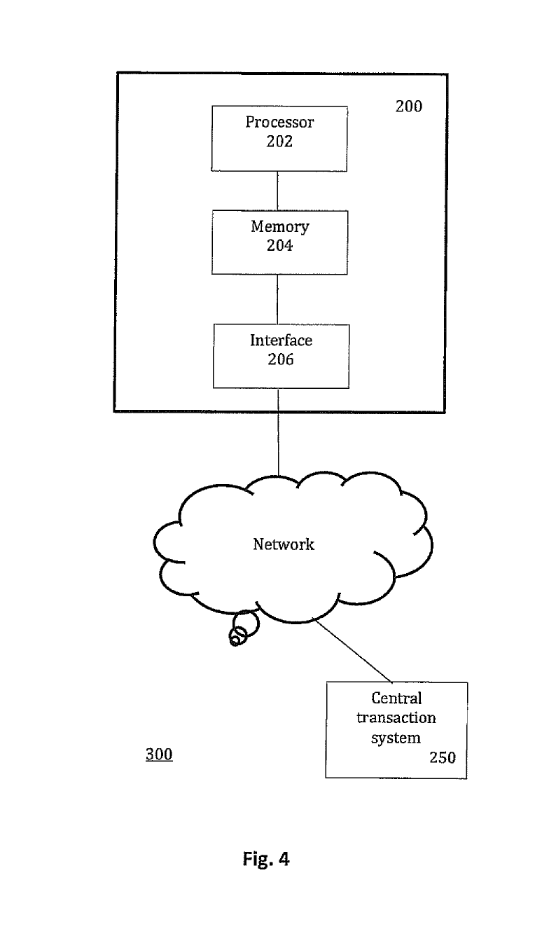

FIG. 4 shows one out of many possible embodiments of the system 300 for handling cashless payments with a payment instrument according to the invention. The system 300 has a device 200 for handling cashless payments via a payment instrument, and a central transaction system 250 for carrying out trade transactions. The device 200 for handling cashless payments is identified basing on a unique address, for example a MAC (Media Access Control) address or another address that guarantees unequivocal identification of the device 200.

In one embodiment a POS (Point-Of-Sale) terminal is used to operate payment instruments. In this case the communication between the POS terminal 200 and the central transaction system 250 may be established via a telephone network or a data network (in this case, the terminal is equipped with a modem), data packet networks, mobile telephony networks, or another network that will allow for a safe (encoded) transmission of data from the POS terminal 200 to the central transaction system 250. The POS terminal 200 is equipped with means for receiving an order to carry out a cashless payment with a payment instrument. It may be, for example, a keyboard 405 for entering the amount to be paid. After entering the amount to be paid, the payment instrument is read out using the means 402, 403, 404 for reading out the payment instrument identifier. The means may be a proximity card reader, a magnetic stripe reader, a smart card reader, a payment handling module, or a keyboard for entering the phone number or password. The payment instrument may be realized in one of many known technologies. It may be a smart card, a card with a magnetic stripe only, a mobile phone or any other mobile device that makes it possible to do payments. Also, it may be another data carrier having small dimensions that allows a customer to use it freely, such as a flash-type memory card, etc.

The system 300 comprises a device 200 with means 409 for generating a secondary identifier, means 407 for establishing communication with the central transaction system 250, and means 409 for transmitting the generated secondary identifier to the receiver of the central transaction system 250. According to the invention, the means is a processor 202 with a memory 204 and software performing the above mentioned functions in the payment terminal 200.

The result of the verification, 110, is sent from the central transaction system 250 to the means 401, 408 for receiving information about material benefits granted to the customer. According to the invention, the means may be a printer 408, a payment terminal screen 401, or a voice channel sounding the granted material benefit. Moreover, the device 200 in the system 300 has means 406 for authorizing the transaction.

In one embodiment, the system 300 for handling cashless payments may have, additionally, links to software programs operating the sales of goods and services in the Internet. In this case, a software application 200 functions as the payment terminal 200. The simplest example of such application is an application for handling payments with a credit card. In such a case, the payment instrument is not read out by the device 200, but the customer enters the card data into relevant fields of a form generated by the application for handling transactions. Also, it is possible that the device 200 will be a computer equipped with a smart card reader or a QR code/barcode reader, and then the application reads the data from the payment instrument using the reader.

Also, the system 300 has means for generating, 409, the secondary identifier, the means comprising means for using a hash function, for example a cryptographic hash function SHA-2, including SHA-256 or SHA-512, or any one-way algorithm that guarantees that there is no possibility to determine the original key basing on the derivative key. According to the invention, the means is the processor 202 with memory 204 and the corresponding software performing the above mentioned functions in the payment terminal 200.

The means 407 for establishing communication with the receiver of the central transaction system 250 communicate with the computer system of the receiver of the central transaction system 250 for handling trade transactions. This communication allows for a safe information exchange between the device 200 and the central transaction system 250. The central transaction system 250, being a component of the system 300, has a data structure in which links of all the customers with payment identifiers are registered, such that, basing on such identifier, an adequate material benefit could be granted to the customer, independently on which payment instrument is he/she paying with.

Moreover, the central transaction system 250 contains information about the sellers along with their offers, rebates, rewards and their loyalty programs. Also, information about realized transactions are registered in this data structure, the information being made available to the owner of the payment terminal 200.

Also, the device 200 in the system 300 has a processor 202 adapted to generating 409 a secondary identifier for the payment instrument identifier, and information about the realized transaction. Depending on an embodiment of the present invention, the processor 202 may be a microprocessor executing instructions of a computer program, a circuit with a built-in firmware or a set of microprocessors. For the operation of the system it is important that the transactions are properly transmitted to the central transaction system 250 and that it is possible to check, for example, which transactions have been done by a given customer and with what payment instrument, what was the transaction amount, and what was subject of the transaction. The payment terminal 200 has an interface 206 that allows for communication with the network and other devices via this communications network. The processor 202 registers customer's material benefits in the data structure of the system 300, if the transaction was realized in the central transaction system 250.

If the customer as been given a material benefit, the central transaction system 250 in the system 300 notifies the customer about this material benefit. The notification may be performed in many ways. In one embodiment, the central transaction system 250 sends an email message to the customer and notifies him/her about the granted discount. The same information may be sent to the customer as an SMS message.

The system 300 makes the data about transactions done with the payment instrument being logged in the central transaction system 250 available to the owner of the payment terminal 200. The information is not limited only to the transactions done by a single customer with a payment instrument at the owner of the payment terminal 200. Because logging in the central transaction system 250 gives benefits related with granting material benefits in different locations of payments, the customer is motivated to buy at points of sale that belong to the central transaction system 250. Having so wide data about the consumer behaviors, the owner of the payment terminal 200 may use it for analytical purposes.

The system 300 allows for a very elastic control over granting material benefits. The granted material benefits may be graded, as said previously, that was not possible using known solutions. Simultaneously, the range of information available to the owners of payment terminals 200 is huge and makes it possible to make better decisions concerning granted discounts, rebates, or tangible rewards.

According to the invention, in the system 300, after registering the customer in the central transaction system 250, at every subsequent verification, 110, the central transaction system 250 identifies a customer automatically basing on his/her phone number, a password identifying the customer, or a secondary identifier assigned to the customer's payment instrument basing on the payment card PAN number, or an arbitrary identifier of the payment instrument. Moreover, a single customer may possess any number of payment cards, passwords, and telephones, as well as other payment instruments, each of them having its own unique number. To any of such numbers a secondary identifier is assigned. Independently on which payment card, payment instrument, or phone number is selected by the customer to make a payment, the same amount of material benefit is granted to him/her.

According to the invention, the device 400 for handling cashless payments comprises means 405 for receiving an order for handling a cashless payment with a payment instrument, means 402, 403, 404 for reading out the payment instrument identifier, means 409 for generating the secondary identifier by modifying the payment instrument identifier using a hash function, means 407 for establishing communication with a receiver of the central transaction system 250, means 409 for transmitting the generated secondary identifier to the receiver of the central transaction system in order to verify whether any material benefit appertains to the customer, means 401, 408 for receiving information from the central transaction system about material benefits granted to the customer, means 406 for authorizing the transaction. The granted material benefit may have a value of zero.

According to the invention, the device comprises means 409 for sending, to the customer, information about granted material benefit.

In an alternative embodiment, in the case the verification 110 is negative, the device 200 comprises means 409 for receiving, from the central transaction system 250, information about the possibility of registering the customer in said central transaction system 250, the registration being carried out after confirming the payment transaction.

The device comprises means for reading 402, 403, 404, 405 the payment instrument identifier, the identifier being, for example, the payment card PAN number, a phone number, any customer's password, or any payment instrument identifier.

Moreover, the device according to the invention comprises means 409 for using a hash function for generating the secondary identifier.

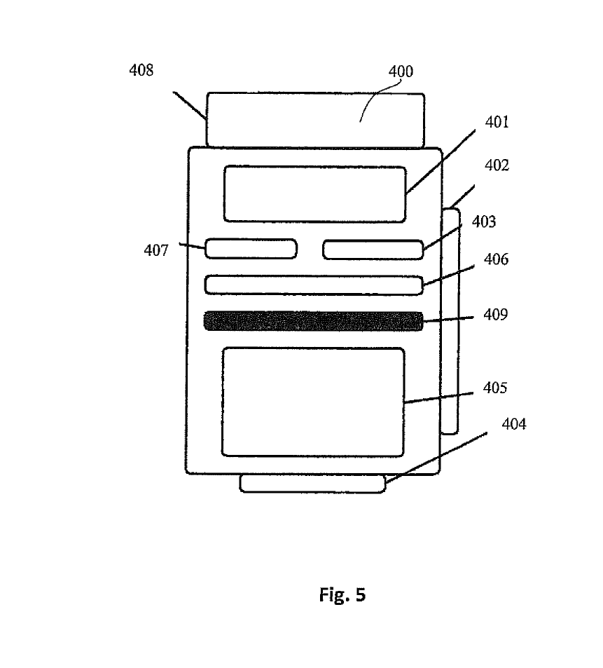

FIG. 5 illustrates an alternative embodiment of a device 400 according to the invention.

The device 400 according to one of many exemplary embodiments is a cuboidal payment terminal. On the surface of the device 400 a means for receiving an order to carry out a cashless payment is located, the means being, for example, a keyboard 405 for entering information into the system for handling cashless payments, for example an amount to be paid for purchases. In an alternative embodiment, the keyboard 405, additionally, functions as a means for reading out the payment instrument identifier if the identifier is a customer's password or his/her phone number. Moreover, in an alternative aspect, a PIN code of the payment instrument is entered using the keyboard in order to authorize the transaction to be realized. The function of the means for reading out the payment instrument identifier may be, for example, performed by a reader 402 with a module for reading out magnetic stripes. Thanks to this reader 402, it is possible to read out and identify payment instruments equipped with a magnetic stripe. Another means for reading in the device 400 is a localized proximity card reader 403. Using the reader 403 it is possible to make cashless payments using proximity payment cards. The device 400 also comprises a reader 404 for smart cards. Using such a reader 404 it is possible to service payment instruments equipped with an electronic chip. It is known from the art that the process of reading out a magnetic stripe or a chip card memory is controlled by a specially programmed processor or a controller. Because the corresponding solutions are known, they will not be described in more details in this document. A means for generating the secondary identifier is the processor 409 that modifies the payment instrument identifier using a hash function. For example the payment card PAN number is blanked out and a cryptographic hash function SHA-2 is created, for example SHA-256 or SHA-512, basing on the payment card PAN number. The anonymization is performed in the device 400. Moreover, the device 400 has means 407 for establishing communication with a receiver of the central transaction system 250. This is a module that makes it possible to receive communication calls and is connected to a communications network. The processor 202 along with the memory module 204, and the software written within the memory module 204, are contained within a module 409 and function as means for transmitting the generated secondary identifier to the receiver of the central transaction system 250 in order to verify whether any material benefit appertains to the customer.

Moreover, the device 400 has a screen 401 in the form of an LCD display, functioning as the means for receiving information from the central transaction system 250. In the display screen 401 displays information about the transaction status, messages informing about actions to be taken for realizing cashless payments, and messages about servicing the payment card by the system for handling cashless payments. Also, a printer 408 is such means.

Moreover, the device 400 has means 406 for authorizing transactions. The authorization is carried out similarly to a method known in the state of the art.

The above mentioned means contained in the device 200 are realized by the processor 202, the memory module 204, and the software stored in the memory module 204 and executed by the processor 202, as well as an interface 206 for network communication.

The means may have form of an electronic circuit. The electronic circuit identifies and interprets instructions according to algorithms and therefore it comprises a processor, a signal processor, a microprocessor as well as programmable or dedicated devices such as ASIC or FPGA circuits. Therefore, the algorithms also may be performed as a software. It is to be appreciated therefore that the present invention may be implemented in various forms of hardware, software, firmware, special purpose processors or combinations thereof, as well as in a typical general purpose computer. Preferably, the present invention is realized as a combination of hardware and software elements. Moreover, advantageously, the software is implemented as a utility computer program contained, in practice, in a device for storing software. The utility program may be downloaded and executed by a device having appropriate architecture.

To illustrate the operation of the system yet more clearly, examples of practical application thereof are given below.

### EXAMPLE 1

In this example a customer buys rollerblades and pays with a payment card. It should be, however, emphasized that the issuer of the payment card not necessarily is a bank. It may be, for example, a chain store or an institution independent on the two mentioned (bank, chain store). The store is equipped with a device 400, according to the invention, that is registered in a system 300 for handling cashless payments. The customer buys the rollerblades and his/her payment instrument, a payment card in this case, is read out by the device 400 that receives an order for handling the cashless payment, 100. The device 400 reads out, 102, the payment card PAN number and then generates, 104, a secondary identifier. Then, the device 400 communicates with a receiver of a central transaction system 250 and transmits, 108, the generated secondary identifier in order to verify whether the customer is already registered in the system and whether he/she takes part in any promotional action at his seller. Next, the central transaction system 250 checks the secondary identifier and searches for any promotions of the store and discounts for this secondary identifier. It selects the most advantageous material benefit available in the store for the transaction being performed by the customer, and sends, 114, to the device 400, information about proposed material benefit that is displayed on the screen of the device 400. The customer, after obtaining the information about the granted material benefit, may accept it or reject it. The customer obtains the information about the purchase amount, for example 400 PLN, and the granted discount of 10% and the amount to be paid automatically reduced by the granted discount—the amount to be paid of 360 PLN. The customer accepts the proposed amount for the purchase of the rollerblades including the discount by pressing a button on the device 400 dedicated for accepting proposed amounts. After accepting the amount to be paid, the customer authorizes, 116, the accepted transaction. After the authorization, 116, the customer's account is charged, 118, for the amount with the granted discount included.

### EXAMPLE 2

In this example, a customer buys a bicycle, and pays with a mobile phone. The store is equipped with a payment terminal 200 that is registered in a system 300 according to the invention for handling cashless payments. The customer buys a bicycle, the payment terminal 200 receives an order for handling the cashless payment, 100. In the payment terminal 200, the customer enters his/her phone number. The payment terminal 200 generates, 104, a secondary identifier for this phone number and communicates with a receiver of a central transaction system 250 in order to transmit, 108, the generated secondary identifier in order to verify whether the customer is already registered in the system and whether he/she takes part in any promotional action at his seller. Next, the central transaction system 250 checks the secondary identifier and searches for the most advantageous promotion of the bicycle store for this customer, and sends, 114, information about proposed material benefit to a printer in the payment terminal 200, via an interface 206. The customer, after receiving the information about granted material benefit in a form of a bicycle light, authorizes, 116, the transaction by means of his/her payment card, where the transaction amount will correspond to the price of the bicycle. The information about the granted material benefit in the form of the bicycle light is sent, 120, as an SMS message, to the customer's mobile phone.

### EXAMPLE 3

In this example, a customer buys a scooter and shoes in an on-line shop for 350 PLN. The customer signs in on the shop Internet website by entering an access password comprising a string of characters. The shop, being registered in a central transaction system 250, receives a message about signing in of a customer. The identifier is the access password to the website. The customer selects a scooter and shoes and proceeds to the payment for the purchase, 100. The on-line shop asks him/her to repeat the access password, 102, for which it generates a secondary identifier, 104. The on-line shop communicates, 106, with a receiver of the central transaction system 250 to which the generated secondary identifier is transmitted, 108. The central transaction system 250 verifies, 110, whether the customer is registered in the system. After a positive verification of the customer, it sends information, to the on-line shop, that for purchases above 100 PLN the customer will obtain 10 points in a loyalty program, whereas for purchases above 300 PLN the customer has a discount of 20% thus giving an amount to be paid of 280 PLN, or the customer may gain 30 points in the loyalty program. The information is displayed, 114, on a computer monitor screen of a mobile device or is sounded by a virtual assistant. The customer, after receiving the information about granted material benefits, decides to get the 20% discount and accepts the material benefit by pressing a corresponding icon assigned to the option of accepting the material benefit. Then, the shop directs the customer to the payment for the purchases, where he/she pays, 116, with a selected payment method. The customer's account is charged for an amount including the granted discount.

### EXAMPLE 4

In this example, a customer buys perfume in a special promotion offering a discount of 50 PLN for a minimal purchase of 200 PLN, paying with a payment card of a bank from which he/she obtained information about this promotion. The store is equipped with a payment terminal 200 that is registered in a system 300 for handling cashless payments. The customer is not registered in the central transaction system 250. The customer chose perfume for 250 PLN. The payment terminal 200 receives an order for a cashless payment 100. In the payment terminal 200, the customer uses a payment card of the bank from which he/she obtained information about the promotion, 102. The payment terminal 200 generates, 104, a secondary identifier for this payment card and communicates with a receiver of the central transaction system 250 in order to transmit, 108, the generated secondary identifier to verify whether the customer takes part in any promotion action at this seller. Then, the central transaction system 250 checks the secondary identifier and searches the most advantageous promotion of the perfume store for this secondary identifier of the customer's payment card, and sends, 114, information about the proposed material benefit to a printer and a display on the payment terminal 200, via an interface 206. The customer, after obtaining the information about the granted material benefit in a form of a 50 PLN discount, authorizes, 116, the transaction and his/her account is charged, 118, for an amount including the granted discount. The information about the granted material benefit in a form of a 50 PLN discount is sent, 120, as an SMS message, to the customer's mobile phone.

1. A method for handling cashless payments with a payment instrument, comprising:
receiving an order to carry out a cashless payment with a payment instrument,
reading out the identifier of this payment instrument,
generating a secondary identifier by modifying the identifier of the payment instrument using a hash function,
establishing communication with a receiver of a central trade transactions carrying out system,
transmitting the generated secondary identifier to the receiver of the central trade transactions carrying out system in order to check whether any material benefit appertains to the customer,
receiving information from the central trade transactions carrying out system about the material benefit granted to the customer,
authorizing the transaction, and
charging the customer's account including the material benefit granted in the previous step.

2. A method according to claim 1, wherein the granted material benefit has a value of zero.

3. A method according to claim 1, wherein the step of transmitting the generated secondary identifier to the receiver of the central trade transactions carrying out system is performed also in order to verify whether the customer is registered in said central transaction system.

4. A method according to claim 1, comprising sending information to the customer about granted material benefit.

5. A method according to claim 3, comprising, in the case of negative verification, a step of receiving from the central trade transactions carrying out system information about a possibility of registering the customer in said central transaction system, the registration being carried out after confirming the payment transaction.

6. A method according to claim 1, wherein the step of reading out the payment instrument identifier is performed by reading one of the payment card PAN number, phone number, or any customer's password or the identifier of any payment instrument.

7. A method according to claim 1, wherein a hash function is used for generating a secondary identifier.

8. A method according to claim 4, wherein the information about the granted material benefit is displayed on one of: a screen of the payment terminal, a screen of the payment instrument, a print printed on a printer, or is generated as a sound signal, or is sent as an SMS message or an email message.

9. A device for handling cashless payments with a payment instrument, comprising:
means for receiving an order to carry out a cashless payment with a payment instrument,
means for reading out the identifier of this payment instrument,
means for generating a secondary identifier by modifying the identifier of the payment instrument using a hash function,
means for establishing communication with a receiver of a central trade transactions carrying out system,
means for transmitting the generated secondary identifier to the receiver of the central trade transactions carrying out system in order to check whether any material benefit appertains to the customer,
means for receiving information from the central trade transactions carrying out system about material benefits granted to the customer,
means for authorizing the transaction.

10. A device according to claim 9, wherein the granted material benefit has a value of zero.

11. A device according to claim 9, comprising means for sending information to the customer about the granted material benefit.

12. A device according to claim 9, comprising, in the case of negative verification, means for receiving from the central trade transactions carrying out system information about a possibility of registering the customer in said central transaction system, the registration being carried out after confirming the payment transaction.

13. A device according to claim 9, comprising means for reading out the payment instrument identifier by reading out one of the payment card PAN number, phone number, or any customer's password or the identifier of any payment instrument.

14. A device according to claim 9, comprising means for using a hash function for generating the secondary identifier.

15. A system for handling cashless payments with a payment instrument, comprising a device for handling cashless payments and a central trade transactions carrying out system, the device comprising:
means for receiving an order to carry out a cashless payment with a payment instrument,
means for reading out the identifier of this payment instrument,
means for generating a secondary identifier by modifying the identifier of the payment instrument using a hash function,
means for establishing communication with a receiver of a central trade transactions carrying out system,
means for transmitting the generated secondary identifier to the receiver of the central trade transactions carrying out system in order to check whether any material benefit appertains to the customer,
means for receiving information from the central trade transactions carrying out system about material benefits granted to the customer,
means for authorizing the transaction.

16. A system according to claim 15, wherein the amount of the granted material benefit does not depend on the type of the payment instrument with which the payment is done.
